(19) United States
(12) Patent Application Publication
(10) Pub. No.: US 2015/0128756 A1
(43) Pub. Date: May 14, 2015

(54) BICYCLE HANDLEBAR

(71) Applicant: TIEN HSIN INDUSTRIES CO., LTD., Taichung City (TW)

(72) Inventor: BLACK GU, Taichung City (TW)

(73) Assignee: TIEN HSIN INDUSTRIES CO., LTD., Taichung City (TW)

(21) Appl. No.: 14/074,867

(22) Filed: Nov. 8, 2013

(51) Int. Cl. B62K 21/12

(52) U.S. Cl. CPC B62K 21/12
USPC 74/551.1

(57) ABSTRACT

A bicycle handlebar includes a main body pivotally connected to a bicycle. A first holding portion and a second holding portion corresponding to the first holding portion are disposed at left and right sides of the main body. The first holding portion and the second holding portion each bend towards a forward riding direction and extend to form a forward bending portion. The forward bending portions each extend towards a backward riding direction to form a backward bending portion. The backward bending portions each extend towards the backward riding direction to form a rear section. A distance between the two backward bending portions is greater than a distance between the two forward bending portions, so as to expand a turning radius of the bicycle handlebar.

### BACKGROUND OF THE INVENTION

1. Field of the Invention

The present invention generally relates to a handlebar, and more particularly to a bicycle handlebar manufactured with ergonomics and facilitating rotary operations.

2. Description of the Prior Art

As shown in FIG. 1A and FIG. 1B, a conventional bicycle handlebar is substantially a hollow tube body made of a metal material or a carbon fiber material, and mainly includes a central tube 1, transversely disposed on a bicycle. A pivotal connection hole (not shown) is disposed in the middle of the central tube 1. A fastener 2 penetrates into the connection hole and then is fastened to a stem 3 of a bicycle, so as to pivotally connect the bicycle handlebar onto the stem 3. Left and right sides of the central tube 1 each extends towards a forward riding direction and bends to form an arc-shaped holding portion 4.

In this way, the rider can not only hold the left and right sides of the central tube 1 respectively but can also hold the holding portions 4. So the rider can change the riding posture to prevent the fatigue generated by keeping the same posture for a long time. Especially, riding the bicycle on a flat road is easier and faster than on a slope, the rider will hold the left and right sides of the central tube 1. Although the rider's posture is upright to cause a large wind resistance, no great effort is required because the road is flat. On the contrary, in the case of climbing and accelerating, in order to reduce the wind resistance to facilitate the forward speed of the bicycle, the two hands of the rider change to hold the holding portions 4, and the rider's body is changed into a stooping posture to reduce the wind resistance, thereby facilitating the forward speed of the bicycle.

However, a distance between the two holding portions 4 of the conventional bicycle handlebar is the same as the width of the central tube 1. When making a turn, if the two hands of the rider hold the left and right sides of the central tube 1, a distance between the hand and a center of the central tube 1 is short, so the relative turning radius is small. However, because the rider's body is upright, the rider's weight proportion borne by the two hands is less, so that the operation is less affected. In the case of climbing and accelerating, the two hands of the rider hold the holding portions 4. Because the holding portions 4 are lower than the central tube 1, the rider's posture is in a stooping state and the two hands bear a large part of the body weigh. A rotational radius r is small, which is unfavorable to make a turn and is easily out of control due to excessive deflection of a front wheel caused by excessively large amplitudes of the turning operation. Moreover, the conventional holding portion 4 is in a form of a straight line and does not meet ergonomics for holding of a human palm in cooperation with four fingers and a thumb, thereby affecting the smoothness of turning made with the hands of the rider.

### SUMMARY OF THE INVENTION

The main objective of the present invention is to solve the problem that a conventional bicycle handlebar has a small rotational radius during turning and cannot meet ergonomics so that the operation is not smooth.

In order to achieve the foregoing objective, the present invention provides a bicycle handlebar including a main body, pivotally connected to a bicycle. A first holding portion and a second holding portion corresponding to the first holding portion are disposed at left and right sides of the main body, respectively. The first holding portion and the second holding portion each bend towards a forward riding direction and extend to form a forward bending portion, and the two forward bending portions each extend towards a backward riding direction to form a backward bending portion. The backward bending portions each extend towards the backward riding direction to form a rear section, and a distance between the two backward bending portions is greater than a distance between the two forward bending portions, thereby facilitating a turning operation of the bicycle.

Furthermore, the distance between the two backward bending portions is greater than a distance between the two rear sections.

Furthermore, the backward bending portion is an arc shape protruding outwards in a direction parallel to the bicycle handlebar.

Furthermore, a central line of the backward bending portion is collinear with a central line of the rear section and deviates outwards further than a central line of the forward bending portion.

Furthermore, at least one anti-slipping plane for a hand to hold and contact is disposed on a surface of the backward bending portion.

Furthermore, the first holding portion and the second holding portion are not collinear with the main body.

Therefore, the distance between the two backward bending portions is greater than the distance between the two forward bending portions. When the hands of a rider hold the backward bending portions to make a turn, the rotational radius of the bicycle handlebar of the present invention is greater than the rotational radius of the conventional bicycle handlebar. When making a turn, the turning amplitude of the bicycle handlebar of present invention is less than that of the conventional bicycle handlebar, thereby solving the problem that the operation of the conventional bicycle handlebar is not sufficiently smooth. An anti-slipping plane for palm holding is disposed on the backward bending portion, thereby implementing a slip prevention and stabilization function for avoiding hand sweating.

The backward bending portion is just used for a palm to hold in cooperation with four fingers, and a thumb presses on the forward bending portion. The backward bending portion is further extended outwards than the forward bending portion, so that the angle and the position of the forward bending portion for the thumb to press and hold just meet the ergonomics, thereby providing comfortable holding feeling.

Further benefits and advantages of the present invention will become apparent after a careful reading of the detailed description with appropriate reference to the accompanying drawings.

### BRIEF DESCRIPTION OF THE DRAWINGS

The present invention will become more fully understood from the detailed description given herein below for illustration only, and thus are not limitative of the present invention, and in which:

FIG. 1A is a schematic plane view of a conventional bicycle handlebar;

FIG. 1B is a partial enlarged view of FIG. 1A;

FIG. 2 is a three-dimensional view of a first embodiment of the present invention;

FIG. 3 is a three-dimensional view of the first embodiment of the present invention in another direction;

FIG. 4A is a plane view of the first embodiment of the present invention;

FIG. 4B is a partial enlarged view of FIG. 4A;

FIG. 5 is a schematic view of a first use situation of the first embodiment of the present invention;

FIG. 6 is a schematic view of a second use situation of the first embodiment of the present invention;

FIG. 7 is a schematic view of a third use situation of the first embodiment of the present invention;

FIG. 8A is a plane view of a second embodiment of the present invention; and

FIG. 8B is a partial enlarged view of FIG. 8A.

### DETAILED DESCRIPTION OF THE INVENTION

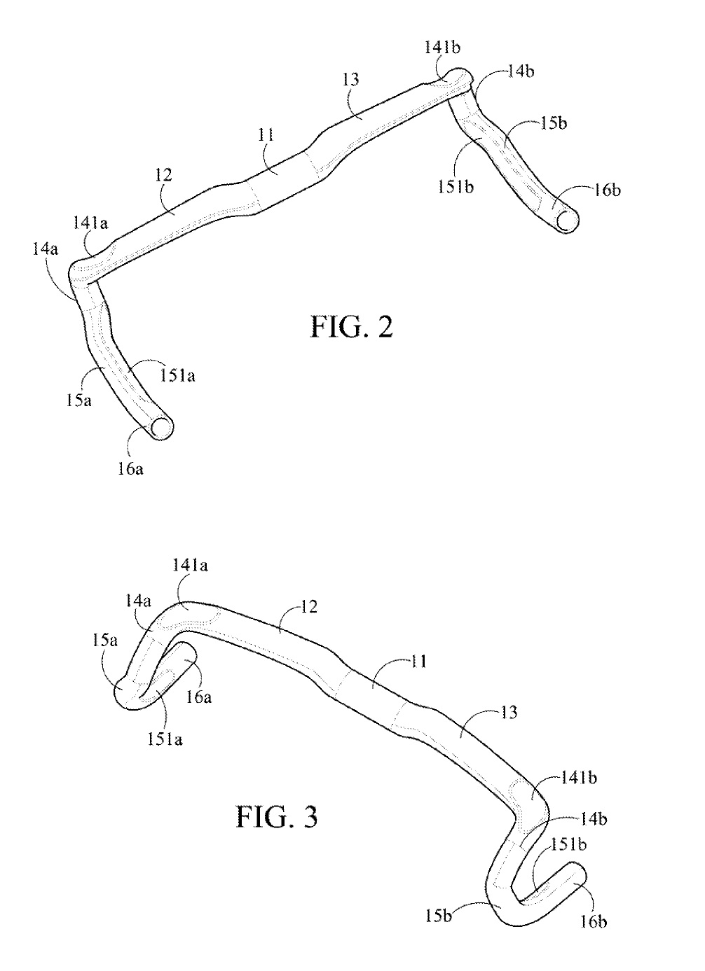

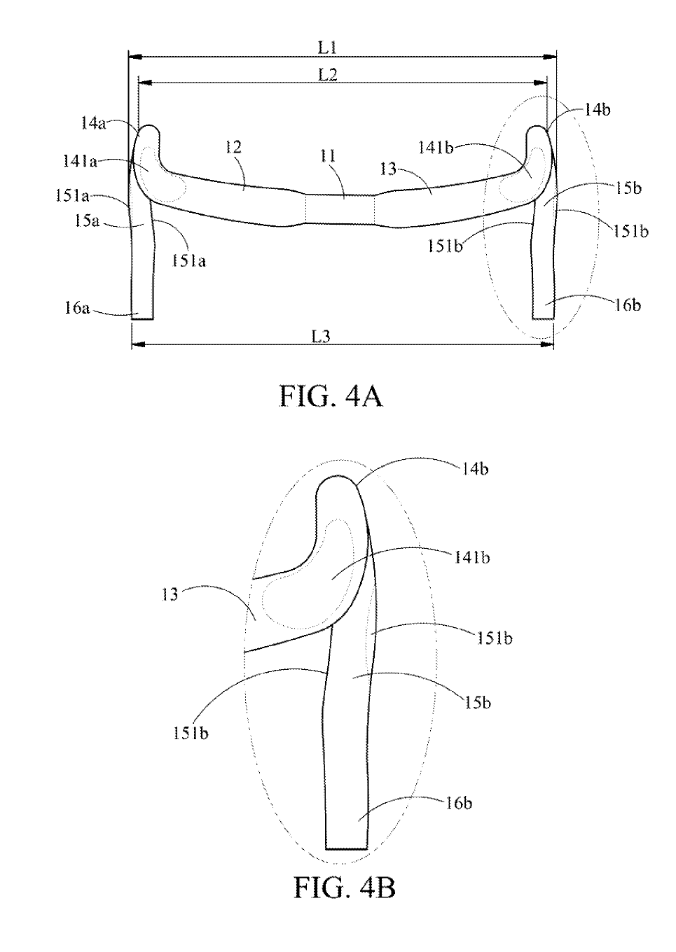

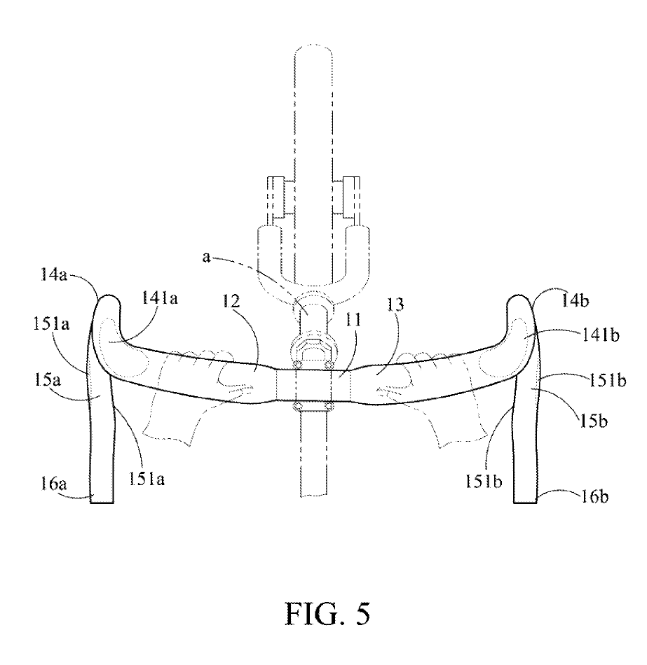

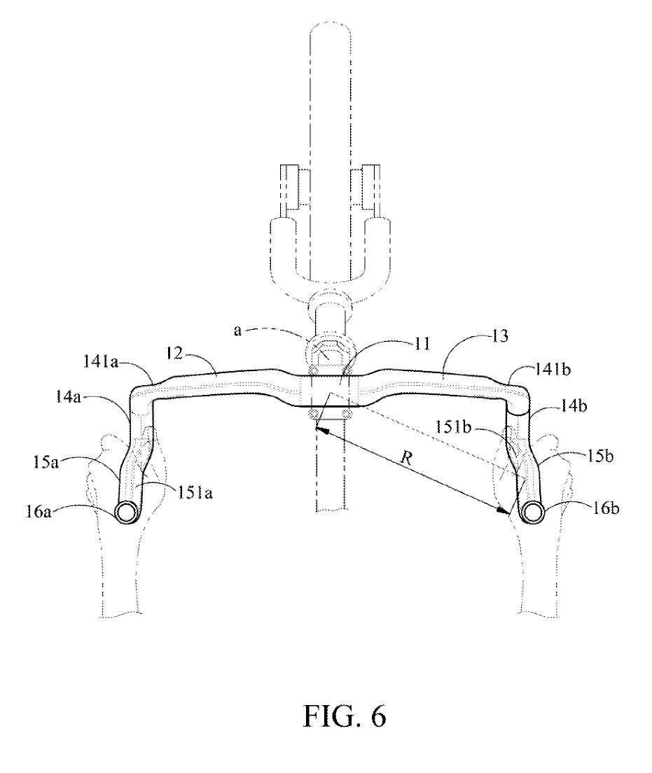

The detailed content and technical description of the present invention are further described through embodiments. Referring to FIG. 2, FIG. 3, FIG. 4A, FIG. 4B, and FIG. 5. FIG. 2 is a three-dimensional view of a first embodiment of the present invention. FIG. 3 is a three-dimensional view of the first embodiment of the present invention in another direction, FIG. 4A is a plane view of the first embodiment of the present invention. FIG. 4B is a partial enlarged view of FIG. 4A. FIG. 5 is a schematic view of a first use situation of the first embodiment of the present invention.

As shown in the figures, a bicycle handlebar of the present invention can be a hollow tube body made of a metal material, for example, an aluminum alloy, or a carbon fiber composite material. As shown in FIG. 2, the bicycle handlebar of a first embodiment of the present invention includes a main body 11, pivotally connected to a bicycle. A first holding portion 12 and a second holding portion 13 are disposed at left and right sides of the main body 11, respectively. Axial lines extending from the first holding portion 12 and the second holding portion 13 are not collinear with the main body 11. The first holding portion 12 and the second holding portion 13 bend towards a forward riding direction and extend to form forward bending portions 14a and 14b respectively. The forward bending portions 14a and 14b extend towards a backward riding direction to form backward bending portions 15a and 15b respectively, and the two backward bending portions 15a and 15b extend towards the backward riding direction and then extend close to each other to form rear sections 16a and 16b respectively.

As shown in FIG. 4A, a distance L1 between the two backward bending portions 15a and 15b is greater than a distance L2 between the two forward bending portions 14a and 14b and greater than a distance L3 between the two rear sections 16a and 16b, so the backward bending portions 15a and 15b are formed into an arc shape protruding towards two sides of the bicycle handlebar, which is equivalent to that a central line of the backward bending portion 15a or 15b deviates outwards further than a central line of the forward bending portion 14a or 14b does.

As shown in FIG. 5, in this embodiment, tube shapes of the forward bending portions 14a and 14b and the backward bending portions 15a and 15b are circular. A tube diameter of the first holding portion 12 is gradually increased from a joint between the first holding portion 12 and the main body 11 and then decreased in a direction towards the forward bending portion 14a; similarly, a tube diameter of the second holding portion 13 is also gradually increased from a joint between the second holding portion 13 and the main body 11 and then decreased in a direction towards the forward bending portion 14b, and then tube shapes of the first holding portion 12 and the second holding portion 13 are approximately ellipses in cooperation with ergonomics for palm holding.

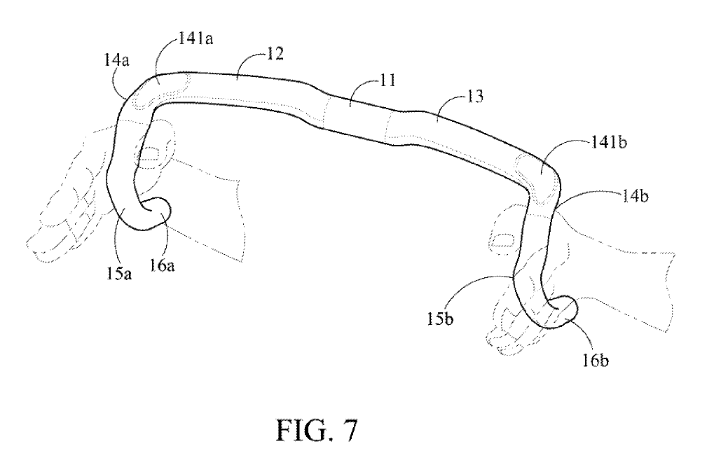

Referring to FIG. 6, an arc portion 141a is formed at a turning portion between the first holding portion 12 and the forward bending portion 14a to fit palm holding, and an arc portion 141b is formed at a turning portion between the first holding portion 12 and the forward bending portion 14b to fit palm holding. At least one anti-slipping plane 151a and at least one anti-slipping plane 151b for palm holding are disposed on surfaces of the backward bending portions 15a and 15b respectively. In this embodiment, two anti-slipping surfaces 151a are disposed at inner and outer sides of the backward bending portion 15a respectively, and two anti-slipping surfaces 151b are disposed at inner and outer sides of the backward bending portion 15b respectively.

Referring to FIG. 5 again, when a rider rides on a flat road, the rider rides forward rapidly due to force saving, so the rider's posture is upright to reduce the body weight borne by two hands. At this time, the two hands of the rider hold the first holding portion 12 and the second holding portion 13.

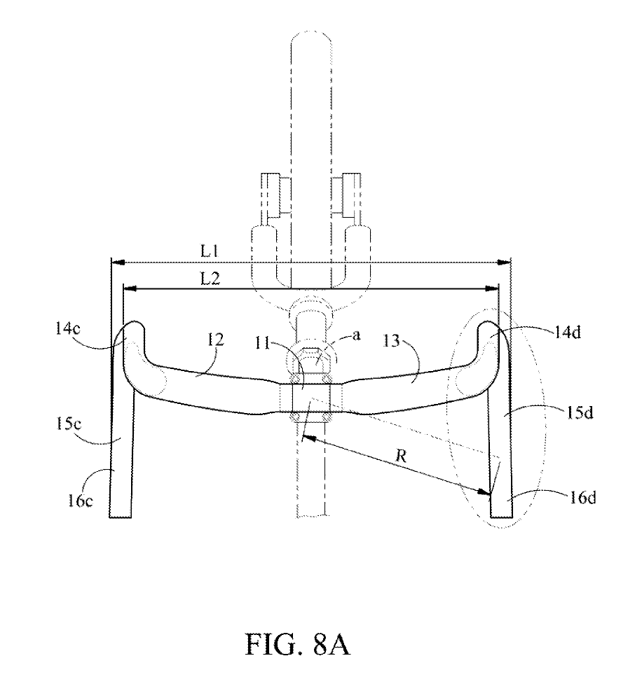

As shown in FIG. 6 and FIG. 7, when the rider rides on a slope, in order to reduce wind resistance to facilitate forward speed of the bicycle, the rider rides in a stooping posture for reducing the height to reduce the wind resistance, thereby facilitating the forward speed. At this time, the backward bending portion 15a or 15b is just used for fitting the palm to hold in cooperation with four fingers, and the thumb presses against the forward bending portion 14a or 14b. The backward bending portions 15a and 15b are expanded outwards further than the forward bending portions 14a and 14b, so that angles and positions of the forward bending portions 14a and 14b for the thumbs to press and hold just meet the ergonomics, thereby providing comfortable holding feeling.

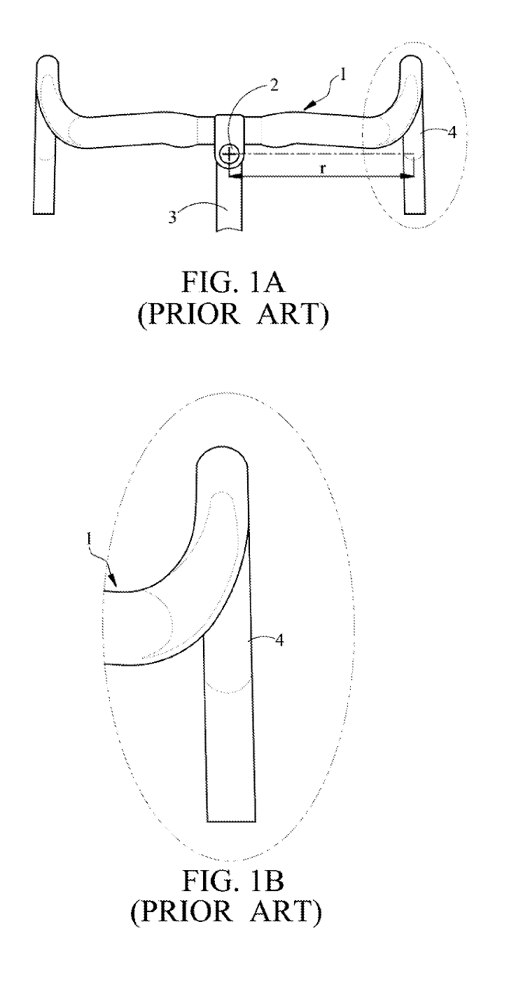

It should be noted that, the distance L1 between the two backward bending portions 15a and 15b is greater than the distance L2 between the two forward bending portions 14a and 14b, so when the hands hold the backward bending portions 15a and 15b to make a turn, as shown in FIG. 6, a rotational radius R provided by the bicycle handlebar of the present invention is greater than the rotational radius r of the conventional bicycle handlebar shown in FIG. 1, and therefore when the rider operates the bicycle handlebar of the present invention to make a turn, a turning amplitude is less than that of the conventional bicycle handlebar, thereby solving the problem that, when the conventional bicycle handlebar is in a high speed riding state, the bicycle is easily out of control due to excessive deflection of affront wheel caused by a small amplitude of deflection of the two hands of the rider. Anti-slipping planes 151a and 151b for palm holding and contact are disposed on the backward bending portions 15a and 15b respectively, thereby implementing a slip prevention and stabilization function for avoiding slippage caused by hand sweating.

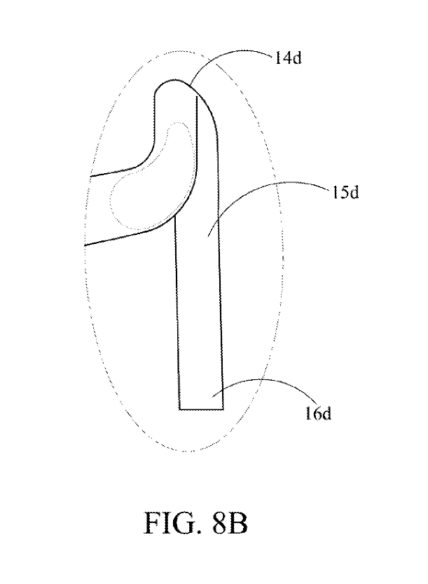

Furthermore, FIG. 8A is a plane view of a second embodiment of the present invention, and FIG. 8B is a partial enlarged view of the second embodiment of the present invention. Referring to FIG. 8A and FIG. 8B, the second embodiment of the present invention includes a main body 11 pivotally connected to a bicycle, where a first holding portion 12 and a second holding portion 13 dispose at left and right sides of the main body 11 respectively. The first holding portion 12 and the second holding portion 13 are not collinear with the main body 11. The first holding portion 12 and the second holding portion 13 bend towards a forward riding direction and extend to form forward bending portions 14c and 14d respectively. The forward bending portions 14c and 14d extend towards a backward riding direction of the bicycle to form backward bending portions 15c and 15d respectively, and the two backward bending portions 15c and 15d extend towards the backward riding direction to form rear sections 16c and 16d respectively.

In this way, a distance L1 between the two backward bending portions 15c and 15d is greater than a distance L2 between the two forward bending portions 14c and 14d, and when making a turn, a rotational radius R of the bicycle handlebar of the present invention is greater than a rotational radius r of the conventional bicycle handlebar shown in FIG. 1, thereby solving the problem that the conventional bicycle handlebar is not stable enough during a turning operation.

The foregoing embodiments are merely preferred embodiments of the present invention and are not intended to limit the implementation scope of the present invention, that is, all simple equivalent variations and modifications made according to the claims and summary of the present invention still fall within the scope covered by the present invention.

What is claimed is:

1. A bicycle handlebar, comprising:
a main body pivotally connected to a bicycle, wherein a first holding portion and a second holding portion are disposed at left and right sides of the main body respectively, the first holding portion and the second holding portion each bend towards a forward riding direction and extend to form a forward bending portion, the two forward bending portions each extend towards a backward riding direction to form a backward bending portion, the two backward bending portions each extend towards the backward riding direction to form a rear section, and a distance between the two backward bending portions is greater than a distance between the two forward bending portions.

2. The bicycle handlebar according to claim 1, wherein the distance between the two backward bending portions is greater than a distance between the two rear sections.

3. The bicycle handlebar according to claim 1, wherein the two backward bending portions are of an arc shape protruding outwards in a direction parallel to the bicycle handlebar.

4. The bicycle handlebar according to claim 1, wherein at least one anti-slipping plane for a hand to hold and contact is disposed on a surface of the backward bending portion.

5. The bicycle handlebar according to claim 1, wherein the first holding portion and the second holding portion are not collinear with the main body.
